(19) United States
(12) Patent Application Publication
(10) Pub. No.: US 2016/0187740 A1
(43) Pub. Date: Jun. 30, 2016

(54) DISPLAY DEVICE

(71) Applicant: InnoLux Corporation, Miao-Li County (TW)

(72) Inventors: Chao-Yin LIN, Miao-Li County (TW); Yan-Shi CHEN, Miao-Li County (TW); Chien-Hua LEE, Miao-Li County (TW)

(21) Appl. No.: 14/953,517

(22) Filed: Nov. 30, 2015

(30) Foreign Application Priority Data
Dec. 24, 2014 (TW) 103145171

(51) Int. Cl. G02F 1/1343; G02F 1/1333; G02F 1/1335

(52) U.S. Cl. CPC G02F 1/134309; G02F 1/133553; G02F 1/133345; G02F 2001/134345

(57) ABSTRACT

The present invention relates to a display device having a plurality of sub-pixels wherein at least one of the sub-pixels has at least one reflection area and at least two transmission areas, comprising: a first substrate; a first electrode layer disposed over the first substrate; a second substrate; a second electrode layer disposed over the second substrate; a liquid crystal layer interposed between the first substrate and the second substrate; and a protrusion unit disposed on the second substrate; wherein the protrusion unit is disposed correspondingly to the reflection area, and the reflection area is interposed between the transmission areas.

### CROSS REFERENCE TO RELATED APPLICATION

This application claims the benefits of the Taiwan Patent Application Serial Number 103145171, filed on Dec. 24, 2014, the subject matter of which is incorporated herein by reference.

### BACKGROUND

1. Field of the Invention

The disclosure relates to a display device, and especially to a transflective display device.

2. Description of Related Art

As the display technology advances, liquid crystal displays (LCDs) with features such as high quality, low power consumption, and no radiation have become the current mainstream display devices. Depending on the different types of light source utilized, the liquid crystal displays can be classified into the transmissive liquid crystal display, the reflective liquid crystal display, and the transflective liquid crystal display. In particular, the transflective liquid crystal display has both the features of lower energy consumption and the capability to display image in a low light condition.

In transflective liquid crystal display, in consideration of the optical path difference between the reflection area and the transmission area, a protrusion unit with an appropriate height is commonly disposed in the reflection area to reduce the thickness of the liquid crystal layer in the reflection area. However, in conventional multi-domain vertical alignment transflective liquid crystal display, the alignments of liquid crystal molecules near the protrusion unit and that of the liquid crystal molecules in the adjacent areas are different. Thus, when an external force is applied to the liquid crystal display panel, the alignment of the liquid crystal molecules is subjected to change easily, resulting in push mura.

Therefore, there is a need to develop a display device not likely to have push mura while retaining the advantages and characteristics of the transflective liquid crystal display device.

### SUMMARY

An object of the disclosure is to provide a display device with improvement in the push mura defect while retaining the advantages and characteristics of the transflective liquid crystal display device by adjusting the configuration of the transmission areas and reflection area with a novel design for the pixel electrodes in a transflective display device.

In order to achieve the above object, the present invention provides a display device having a plurality of sub-pixels wherein at least one of the sub-pixels has at least one reflection area and at least two transmission areas, comprising: a first substrate; a first electrode layer disposed over the first substrate; a second substrate; a second electrode layer disposed over the second substrate; a liquid crystal layer interposed between the first substrate and the second substrate; and a protrusion unit disposed on the second substrate; wherein the protrusion unit is disposed correspondingly to the reflection area, and the reflection area is interposed between the transmission areas.

In an embodiment, the second electrode layers of adjacent sub-pixels are electrically connected to each other and the first electrode layers of adjacent sub-pixels are electrically isolated from each other by a gap disposed in between.

In an embodiment, the second electrode layers of adjacent sub-pixels are a full conductive layer.

In an embodiment, the protrusion unit has an inclined surface disposed correspondingly to a boundary between the reflection area and the transmission area.

In an embodiment, the transmission areas form a multi-domain structure.

In an embodiment, a light passes through the gap between two adjacent sub-pixels forms a dark line.

In an embodiment, the display device may further comprise a reflection layer disposed correspondingly to the reflection area.

In an embodiment, the first electrode layer may be a pixel electrode.

In an embodiment, the display device may further comprise an insulation layer disposed between the first substrate and the first electrode layer.

In an embodiment, in the reflection area, the insulation layer further comprises a micro-structure formed on a surface of the insulation layer facing towards the second substrate.

In an embodiment, the display device may further comprise a scan line disposed on the first substrate and disposed correspondingly to the reflection area.

### BRIEF DESCRIPTION OF THE DRAWINGS

FIG. 1A shows a cross-sectional view of the display device according to the embodiment of the disclosure.

FIG. 1B shows a top view of the display device according to the embodiment of the disclosure.

FIG. 2 shows a schematic diagram of the distribution of the liquid crystal molecules in the transmission areas of the display device according to the embodiment of the disclosure.

FIG. 3 shows a schematic diagram of the transflective liquid crystal display device according to the comparative embodiment of the disclosure.

FIG. 4 shows a voltage-transmittance plot according to the Test Example of the disclosure.

### DETAILED DESCRIPTION

Hereinafter, exemplary examples of the disclosure will be described in detail. However, the disclosure is not limited to the examples disclosed below, but can be implemented in various forms. The following examples are described in order to enable those of ordinary skill in the art to embody and practice the disclosure. In addition, those skilled in the art will appreciate that various modifications, additions, and substitutions are possible.

### Embodiment

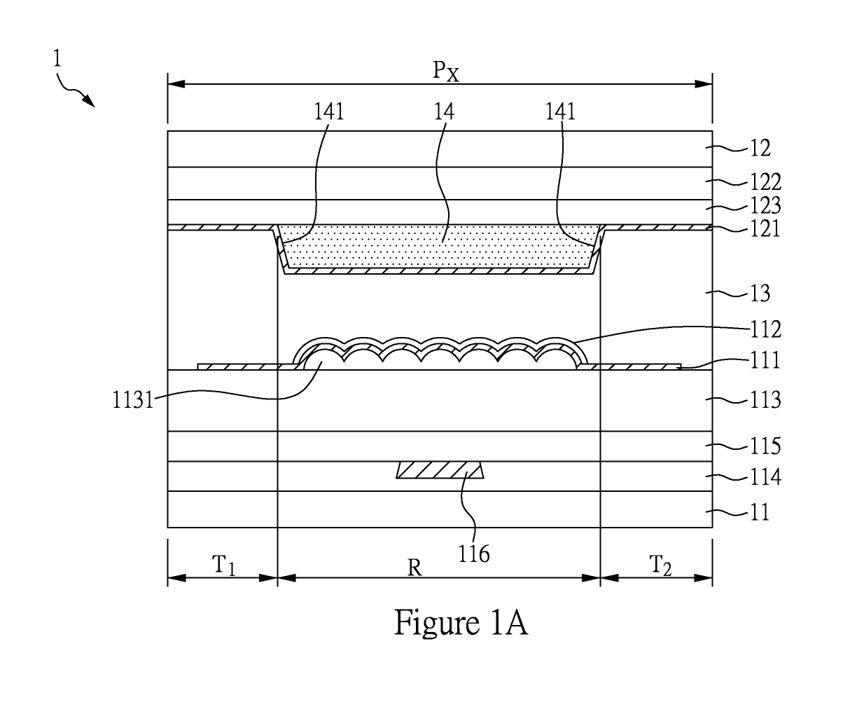

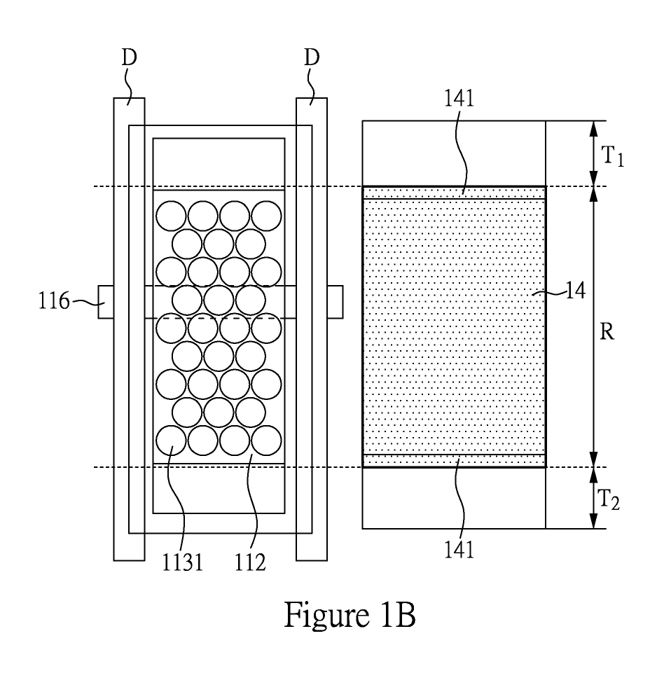

Please refer to FIG. 1A. FIG. 1A shows a cross-sectional view of the display device according to this embodiment. The display device 1 of the present embodiment has a plurality of sub-pixels Px. As FIG. 1 shows, each of the sub-pixels Px has at least one reflection area R and at least two transmission areas T1 and T2. The display device 1 comprises: a first substrate 11; a first electrode layer 111 disposed over the first substrate 11; a second substrate 12; a second electrode layer 121 disposed over the second substrate 12, wherein the second electrode layer 121 is opposite to the first electrode layer 111; a liquid crystal layer 13 containing a plurality of liquid crystal molecules (not shown) interposed between the first substrate 11 and the second substrate 12; and a protrusion unit 14 disposed between the second substrate 12 and the second electrode layer 121. In particular, the protrusion unit 14 is disposed correspondingly to the reflection area R. The reflection area R is interposed between the transmission areas T1 and T2. In this embodiment, the first electrode layer 111 serves as a pixel electrode on an array substrate while the second electrode layer 121 serves as a common electrode on a color filter substrate.

Please still refer to FIG. 1A. In this embodiment, the display device 1 further comprises: a reflection layer 112 disposed correspondingly to the reflection area R, wherein the reflection layer 112 may be disposed above or below the first electrode layer 111; an insulation layer 113 including a micro-structure 1131 formed on a surface of the insulation layer 113 facing towards the second substrate 12, wherein the insulation layer 113 is disposed between the first substrate 11 and the first electrode layer 111; a buffer layer 114 disposed between the first substrate 11 and the insulation layer 113; a passivation layer 115 disposed between the buffer layer 114 and the insulation layer 113; a scan line 116 disposed between the buffer layer 114 and the passivation layer 115 and disposed correspondingly to the reflection area R; a color filter 122 interposed between the second substrate 12 and the second electrode layer 121; and a protection layer 123 interposed between the color filter 122 and the protrusion unit 14.

Please refer to FIG. 1B. FIG. 1B shows a top view of the display device according to this embodiment. The left of FIG. 1B is a top view of the first substrate 11 and the right of FIG. 1B is a top view of the second substrate 12. To illustrate the technical features of the disclosure more clearly, FIG. 1B only shows one single sub-pixel. However, the technical features of the disclosure should not be limited thereto. As shown in FIG. 1B, the sub-pixel is defined by two data lines D and the scan line 116. The sub-pixel comprises one reflection area R and two transmission areas T1 and T2. As described above, the reflection area R is interposed between the two transmission areas T1 and T2. As the left of FIG. 1B shows, the reflection layer 112 is disposed on the micro-structure 1131 on the first substrate 11 corresponding to the reflection area R. Accordingly, the reflection layer 112 will have an appearance similar to the micro-structure 1131. Consequently, the reflection efficiency of the reflection layer 112 will be enhanced. As the right of FIG. 1B shows, the protrusion unit 14 is disposed on the second substrate 12 corresponding to the reflection area R. Moreover, as FIGS. 1A and 1B show, the protrusion unit 14 may have an inclined surface 141 disposed correspondingly to a boundary between the reflection area R and the transmission areas T1 and T2. The inclined surfaces 141 of the protrusion unit 14 face towards the transmission areas T1 and T2 in each sub-pixel. Accordingly, the protrusion unit 14 may reduce the thickness of the liquid crystal layer 13 in the reflection area R to appropriately adjust the optical path difference in the reflection area R. Furthermore, the protrusion unit 14 may also align the liquid crystal molecules.

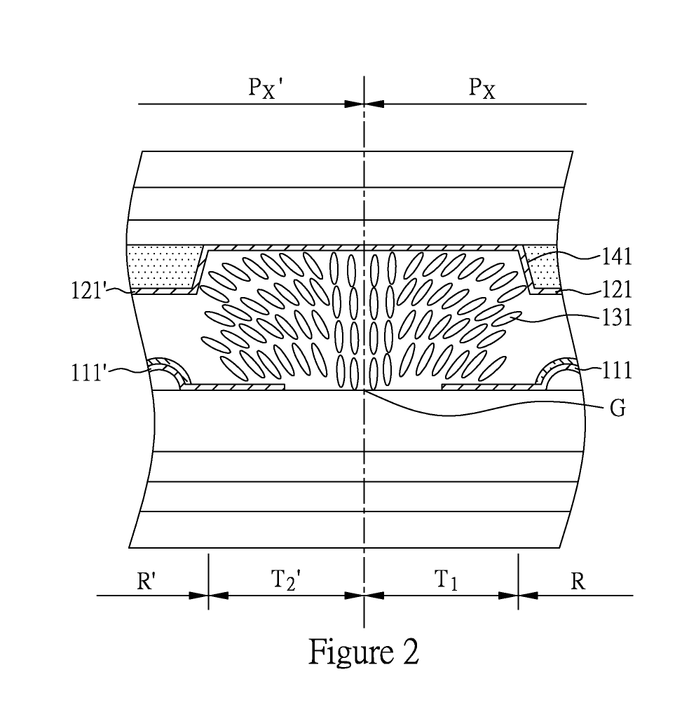

Please refer to FIG. 2. FIG. 2 shows a schematic diagram of the distribution of the liquid crystal molecules in the transmission areas of the display device according to this embodiment. As shown in FIGS. 1A and 2, the transmission areas T1 and T2 of each sub-pixel Px are respectively disposed at the two sides of the reflection area R. In other words, one of the transmission areas (for example, T1) of each sub-pixel Px is connected to one of the transmission areas (for example, T2′) of the adjacent sub-pixel Px′. In addition, as shown in FIG. 2, in the display device 1 of the present embodiment, the second electrode layer 121 of the sub-pixel Px is electrically connected to the second electrode layer 121′ of the adjacent sub-pixel Px′. The second electrode layer 121 of the sub-pixel Px and the second electrode layer 121′ of the adjacent sub-pixel Px′ are a full conductive layer. The first electrode layer 111 of the sub-pixel Px and the first electrode layer 111′ of the adjacent sub-pixel Px′ are electrically isolated from each other by a gap G disposed in between. Accordingly, as shown in FIG. 2, the liquid crystal molecules 131 in the transmission areas T1 and T2′ of the adjacent sub-pixels Px and Px′ may be align in a variety of directions by the inclined surfaces 141 and the gap G Subsequently, a multi-domain structure is formed, wherein the liquid crystal molecules 131 are inclined substantially towards the gap G. A light passes through the gap G between the adjacent sub-pixels Px and Px′ forms a dark line.

The formation of the multi-domain structure between two of the transmission areas is different between that used by the disclosure and that of the conventional method. Specifically, the conventional method uses an opening in a common electrode of a color filter substrate and a division of a pixel electrode into a transmission area and a reflection area to cause a multi-domain partitioning of liquid crystal molecules. However, as shown in FIGS. 1A, 1B, and 2, the display device 1 of the present embodiment utilizes the gap G between the first electrode layers (pixel electrodes) and the inclined surfaces 141 of the protrusion units 14 to cause the liquid crystal molecules 131 to align in a variety of directions, thereby forming a multi-domain structure. Compared to the conventional method, the multi-domain partitioning of the liquid crystal molecules 131 in the display device 1 of the present embodiment causes the liquid crystal molecules 131 to substantially incline towards the gap G between the first electrode layers 111. Consequently, the display device 1 of the present embodiment may have lesser push mura defect caused by the differences in the alignments among the liquid crystal molecules in the conventional transflective display device.

### Comparative Embodiment

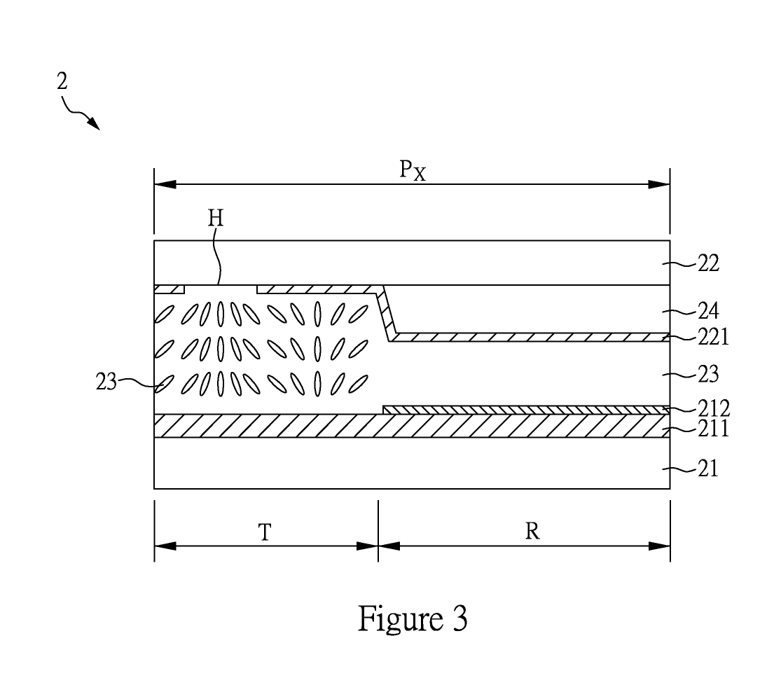

The comparative embodiment of the present invention is a conventional transflective display device. As shown in FIG. 3, in the display device 2 of the conventional multi-domain vertical alignment transflective liquid crystal display, the display device 2 comprises a plurality of sub-pixels Px. Each of the sub-pixels Px has one transmission area T and one reflection area R. In the reflection area R, the display device 2 comprises a protrusion unit 24 to adjust the optical path difference in the reflection area R and to align the liquid crystals. Moreover, the display device 2 employs a hole H in the common electrode 221 and a protrusion unit 24 to form a multi-domain structure for the liquid crystal molecules 231 in the transmission area T.

Test Example

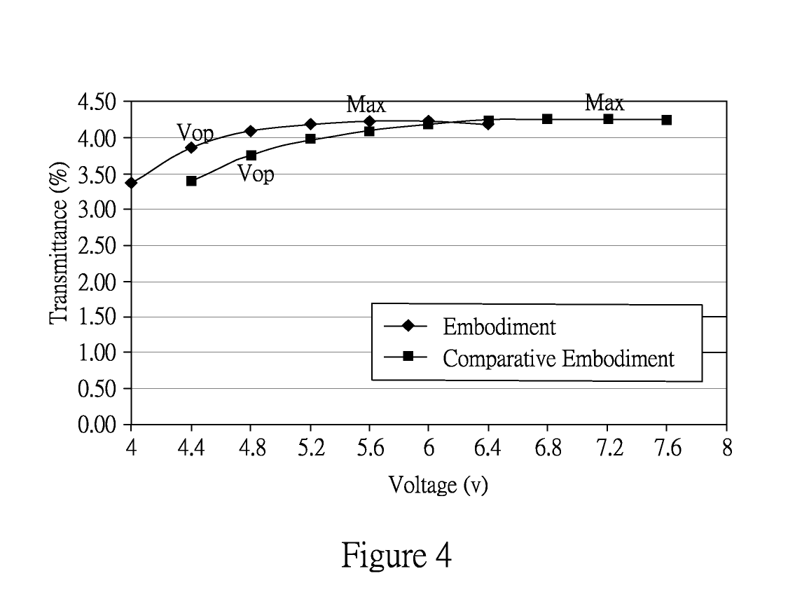

Please refer to FIG. 4. FIG. 4 shows the transmittances of the display devices prepared according to the above Embodiment and the Comparative Embodiment at different driving voltages. The horizontal axis represents voltage (V) and the vertical axis represents transmittance (%). As shown in FIG. 4, at the same level of transmittance, the driving voltages required for the Embodiment are lower than that of the

Comparative Embodiment. In other words, compared to the Comparative Embodiment, the display devices according to the Embodiment of the present invention have the advantages of stable alignment and low power consumption.

Although the disclosure has been explained in relation to its embodiment, it is to be understood that many other possible modifications and variations can be made without departing from the spirit and scope of the invention as hereinafter claimed.

What is claimed is:

1. A display device having a plurality of sub-pixels wherein at least one of the sub-pixels has at least one reflection area and at least two transmission areas, comprising:
a first substrate;
a first electrode layer disposed over the first substrate;
a second substrate;
a second electrode layer disposed over the second substrate;
a liquid crystal layer interposed between the first substrate and the second substrate; and
a protrusion unit disposed on the second substrate;
wherein the protrusion unit is disposed correspondingly to the reflection area, and the reflection area is interposed between the transmission areas.

2. The display device of claim 1, wherein the second electrode layers of adjacent sub-pixels are electrically connected to each other and the first electrode layers of adjacent sub-pixels are electrically isolated from each other by a gap disposed in between.

3. The display device of claim 2, wherein the second electrode layers of adjacent sub-pixels are a full conductive layer.

4. The display device of claim 1, wherein the protrusion unit has an inclined surface disposed correspondingly to a boundary between the reflection area and the transmission area.

5. The display device of claim 4, wherein the transmission areas form a multi-domain structure.

6. The display device of claim 2, wherein a light passes through the gap between two adjacent sub-pixels forms a dark line.

7. The display device of claim 1, further comprising a reflection layer disposed correspondingly to the reflection area.

8. The display device of claim 2, wherein the first electrode layer is a pixel electrode.

9. The display device of claim 1, further comprising an insulation layer disposed between the first substrate and the first electrode layer.

10. The display device of claim 9, wherein, in the reflection area, the insulation layer further comprises a micro-structure formed on a surface of the insulation layer facing towards the second substrate.

11. The display device of claim 1, further comprising a scan line disposed on the first substrate and disposed correspondingly to the reflection area.
